(19) United States
(12) Patent Application Publication
(10) Pub. No.: US 2007/0114927 A1
(43) Pub. Date: May 24, 2007

(54) Cathode with integrated getter and low work function for cold cathode methods for manufacturing such a cathode

(75) Inventors: Alessio Corazza, Como CO (IT); Vincenzo Massaro, Albairate MI (IT)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: SAES GETTERS S. P. A., LAINATE MI (IT)

(21) Appl. No.: 10/595,271

(22) PCT Filed: Nov. 9, 2004
(86) PCT No.: PCT/IT04/00614

§ 371 Date: Jan. 11, 2007

(30) Foreign Application Priority Data
Nov. 14, 2003 (IT) MI2003 A 002208

(51) Int. Cl. H01J 17/24

(52) U.S. Cl. 313/553

(57) ABSTRACT

A cathode (11; 20; 30) is provided for cold cathode lamps having the surface of the cathode at least partially coated with a layer of a getter material (15; 26; 31). The coating allows a reduction of the work function value of the cathode (11; 20; 30) and therefore a reduction of the power consumption of the lamp.

### CROSS-REFERENCE TO RELATED APPLICATIONS

This application is a Section 371 of International Application No. PCT/IT2004/000614, filed Nov. 9, 2004, which was published in the English language on May 26, 2005, under International Publication No. WO 2005/048293 A2.

### BACKGROUND OF THE INVENTION

The present invention relates to a cathode for cold cathode lamps, having an integrated getter and with a reduced value of the work function, which allows a decrease in the power consumption of the lamps in which it is used.

Cold cathode lamps are a kind of discharge lamp. Discharge lamps are all those lamps wherein the light emission takes place as a consequence of electric discharge in a gas means. The discharge is triggered and supported by the potential difference applied to two electrodes (called cathodes) placed at opposite ends of the lamp. The family of discharge lamps comprises also the so called hot cathode lamps, but cold cathode lamps are preferable because they last much longer (40,000-50,000 operation hours for cold cathode lamps versus 12,000-15,000 for hot cathode lamps).

The cathodes of cold cathode lamps may be shaped as a metal strip or metal full cylinder. The preferred geometry is however a hollow one: in this case the cathode has the shape of a hollow cylinder, open at the end facing the discharge zone and closed at the opposite end. As well known in the art, a first advantage of hollow cathodes with respect to other shapes of cathodes is a lower potential difference (by about 5-10%) required for lamp functioning. Another advantage is a lower intensity of the “sputtering” phenomenon of the cathode, that is the emission of atoms or ions of the material of the cathode which may deposit on adjacent surfaces, including the glass walls of the lamp, reducing the light output of the latter. The hollow cathodes are particularly suitable for being used in miniaturized lamps, as for example lamps for the back-lighting of liquid crystal displays (commonly known as LCDs). Examples of lamps with hollow cathodes are disclosed, for example, in U.S. Pat. Nos. 4,437,038 and 4,885,504 and in Japanese patent application publication No. 2000-133201.

When a cold cathode lamp is turned on, the first electron emission occurs due to the electric art, which, if sufficiently high, is capable of extracting electrons from the material forming the cathode. Typical values of potential difference to be applied to the electrodes of hollow cathode lamps for the ignition thereof are of the order of thousands of volts (V), for example between about 1000 and 2000 V; this ignition voltage is known in the art as “starting voltage.” When the discharge has been started (normally after less than one second), the cathodes become hot, and also the thermoionic effect contributes to the emission. While the lamp is operating, the potential difference to be supplied to the cathodes is set to values of a few hundred volts, for example between about 300 and 600 V.

The power consumption of lamps is in any case related to the energy value required for extracting electrons from the material of the cathodes, both in the ignition phase and when the discharge has been established. This energy value is known as “work function”, indicated in literature with the Greek letter Φ, and is a typical value for each individual material (even if it can vary in relation to some parameters, such as the crystalline face from which the electrons are emitted, or the contamination state of the emitting surface). In the end, the power consumption of a lamp depends directly on the work function of its cathodes.

The cathodes of cold cathode lamps may be made of metals, such as niobium and tantalum, both of which are too expensive for practical use; tungsten, having work function values between about 4.2 and 4.6 electron volts (eV); nickel, having work function values between about 4.7 and 5.3 eV; or, more commonly, molybdenum, having work function values between about 4.4 and 4.9 eV. In the case of hollow cathodes, especially of small dimensions, the metal used should have good characteristics of mechanic malleability. Tungsten is practically not used for these cathodes, while molybdenum has industrial application, but because of the difficulty of working, cathodes made of this metal are rather expensive. Nickel may thus be preferable, since it has good malleability and low cost, even if it has the disadvantage of relatively high work function values.

Reduction of power consumption is a constant need of manufacturers of lamps or devices in which these are used, both in fixed and, above all, portable applications, where energy is supplied by batteries or accumulators which have a finite energy reserve. In the case of portable computers, for example, the screen is generally of the LCD type, retro-illuminated by one or two linear cold cathode fluorescent lamps with a diameter of a few millimeters. Illumination of the screen is the greater contribution to the consumption of the accumulator of the computer, limiting the hours of autonomy. LCD screens for other applications (for example domestic television screens) may comprise from four to ten fluorescent lamps.

To reduce the work function of the cathodes, and thus the power consumption of the lamps, it is known to deposit on the surface of such cathodes an emissive material having a work function lower than that of the underlying metal.

Another requirement of cold cathode lamp manufacturers is to ensure a constant composition of the atmosphere in which the discharge takes place. As a matter of fact, it is known that some impurities alter the operation characteristics of the lamps. For example, oxygen may seize the mercury necessary for the operation of fluorescent lamps, while hydrogen may alter the electric parameters of the discharge, in particular by increasing the starting voltage. For this purpose, it is known to add inside the lamps a getter material, that is, a material capable of chemically binding the impurities present in the gas in which the discharge takes place. Getter materials widely used for this purpose are, for instance, the zirconium-aluminum alloys disclosed in U.S. Pat. No. 3,203,901; the zirconium-iron disclosed in alloys U.S. Pat. No. 4,306,887; the zirconium-vanadium-iron alloys disclosed in U.S. Pat. No. 4,312,669; and the zirconium-cobalt-mischmetal alloys disclosed in U.S. Pat. No. 5,961,750 (mischmetal, also referred to MM in the following, is a mixture of rare earth metals with the possible addition of yttrium and/or lanthanum).

Even though, in some cases, the getter is introduced into the lamp simply in the shape of a pill formed only of powders of the material, it is much more preferable that it be in the shape of a device in which the getter material is present in a container or on a metallic support, and that the device be fastened to any constituting element of the lamp. The reason is that a non-fastened getter is not generally in the hot areas of the lamp, and thus its gas sorption efficacy decreases. Moreover, it may interfere with the luminous emission. An example of a getter device for lamps is disclosed in U.S. Pat. No. 5,825,127. The getter device may, for example, be fastened (normally with welding spots) to the support for the cathode, while in some cases a dedicated support is added to the lamp. In any case, additional steps are required in the manufacturing process of the lamp. Furthermore, in the case of miniaturized lamps, such as those used to back-light LCDs, it is difficult to find a suitable arrangement for the getter device inside the lamp, and the assembling operations of the device may be extremely difficult. International patent application publication No. WO 03/044827, in the name of SAES Getters S.p.A., discloses a hollow cathode in which the getter material is directly deposited on some areas of the surface of the cathode itself. According to the teaching of this international application, the getter material may be selected from among titanium, vanadium, yttrium, zirconium, niobium, hafnium and tantalum, or among the alloys based on zirconium or titanium with one or more elements selected from the transition metals and aluminum.

European published patent application EP-A-0675520 discloses a hollow cathode whose interior is partially coated with a deposit constituted of powders of alumina and zirconium, the first having the function of decreasing the work function of the cathode and the second having the function of a getter for the impurities. The deposit is formed by partially dipping the metallic cylinder, which constitutes the structure of the cathode, in a paste containing the mentioned materials in a suspension made of a water-acetone mixture containing a binding material. According to the teaching of this document, only the internal side of the cathode is coated, in order to avoid the sputtering of the material of the emissive mixture that would occur if this were present on the outer surface. Furthermore, for the same reason, it is preferable to avoid the presence of the emissive deposit also in an internal area of the cathode corresponding to a cylindrical surface at the end of the cathode facing the interior of the lamp. The deposits formed in this manner have, however, the problem of a non-negligible loss of powder, which causes a degradation of the functionality of the cathode with time.

### BRIEF SUMMARY OF THE INVENTION

The object of the present invention is to provide a solution to the above-described problems. In particular, an object of the present invention is to provide a cathode at least partially coated with a deposit of a single material, which allows a decrease in the power consumption of the lamps in which the cathode is inserted and to integrate the getter function.

This object is achieved with a cathode for cold cathode lamps, at least partially coated with a getter material comprising a metallic bearing part at least partially coated with a layer of getter material, wherein the getter material is selected from:
alloys comprising zirconium, cobalt and one or more components selected from yttrium, lanthanum or rare earths such that, in the ternary diagram of weight % compositions, they are enclosed in the polygon defined by the points:
Zr 81%-Co 9%-A 10%
Zr 68%-Co 22%-A 10%
Zr 74%-Co 24%-A 2%
Zr 88%-Co 10%-A 2%
wherein A is an element selected from yttrium, lanthanum, rare earths or mixtures thereof;
alloys consisting of yttrium and aluminum containing at least 70% by weight of yttrium; and
alloys consisting of yttrium and vanadium containing at least 70% by weight of yttrium.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a cut-out view of the end of a lamp in which a cathode of the invention is present;

FIGS. 2 and 3 are sectional views of two cathodes according to one preferred embodiment of the invention;

FIGS. 4 and 5 are graphs representing the gas sorption characteristics of two cathodes according to the invention.

### DETAILED DESCRIPTION OF THE INVENTION

The inventors have found that a cathode at least partially coated with a getter material formulated as described, besides integrating the getter function on the cathode, also achieves the effect of decreasing the energy required for the emission of electrons, by decreasing the work function of the cathode itself.

The deposition of getter material according to the invention may be advantageously accomplished on cathodes of any geometry, for example strip-shaped, full or hollow cylinder-shaped.

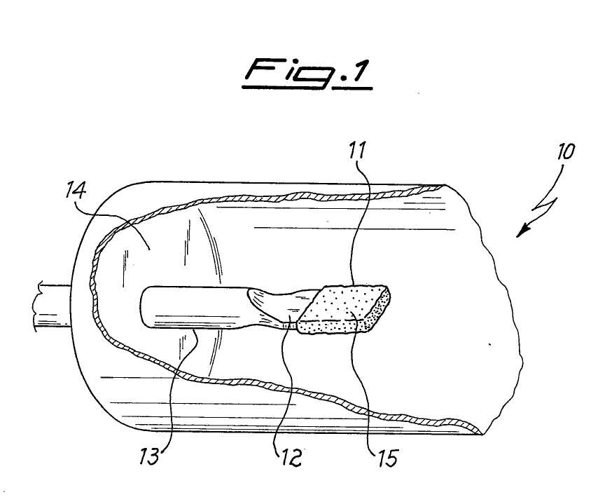

FIG. 1 shows a cut-out view of the end of a lamp 10, containing a cathode 11, in which the cathode is exemplified by a simple metal strip 12, obtained by tapering a metallic wire 13 passing through the glass of the bottom wall 14 of the lamp. A fraction of the surface of the strip 12 is covered with a getter material 15 of the invention. A cathode completely analogous to that of FIG. 1, but full cylinder shaped, may be obtained by coating the end of wire 13 with getter material without previously tapering the wire.

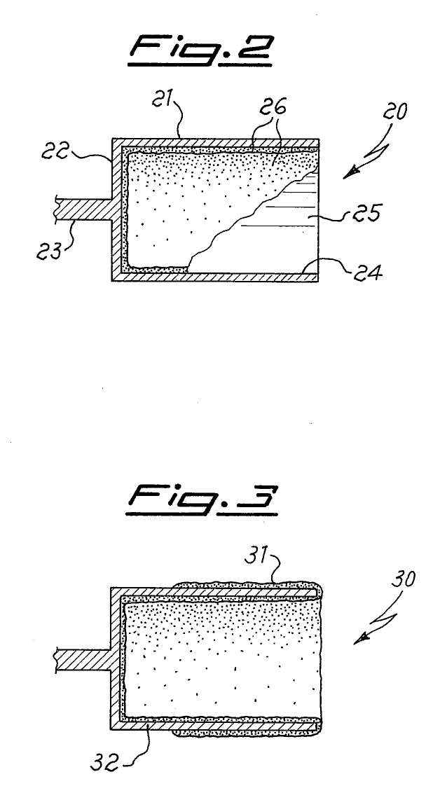

As before, the preferred shape for the cathode is a hollow one. As is known, in hollow cathodes the discharge takes place mainly inside the cavity. Therefore, it is necessary that the inside be the coated part, while the outside of the cathode may be coated or not. Coating the outside also has the advantage of increasing the quantity of getter material, and thus the capacity for removal of impurities from the internal atmosphere of the lamp. Since in hollow cathodes the discharge takes place mainly inside the cavity, the fraction of getter material on the outer surface of the cathode performs mainly the gettering function, while the material inside performs also the function of decreasing the work function of the cathode. In FIGS. 2 and 3, which illustrate only the cathode in section, two possible embodiments of hollow cathodes according to the invention are shown. Cathode 20 is formed of a cylindrical part 21 with a closed end 22 to which a brace 23 is fastened, which generally is a metallic wire soldered on the glass of the end of the lamp as shown in the case of FIG. 1. The inner surface 24 of the cathode, which defines the cavity 25, is coated with getter material 26. In order to show some details, a partial coating of surface 24 is shown in FIG. 2, but this coating is meant to be complete. The preferred material for producing the metallic part of the cathode is nickel, which is easily mechanically worked. The backing wire 23 is preferably made of materials which have a thermal expansion similar to that of the glass of the envelope of the lamp, in order to reduce the risks of breaking the glass, because of thermal shocks, during the sealing and the on/off phases of the lamp. A possible material for this is molybdenum. Brace 23 may be fastened to part 22 for example by soldering or crimping.

In the case of cathode 30 shown in FIG. 3, the coating with getter material 31 is present both inside the cavity and on the external surface of the metallic part 32. As for the rest, this cathode is completely analogous to that of FIG. 2.

As getter materials useful in the present invention are the alloys described in U.S. Pat. No. 5,961,750 of SAES Getters S.p.A. Particularly preferred is the use of the alloy having the weight per cent composition Zr 80%-Co 15%-MM 5%, produced and sold by SAES Getters under the mark St 787. Mischmetal is the name of several mixtures of rare earths which may have different formulations. Generally, the elements present in greatest quantity are cerium, lanthanum and neodymium, with smaller quantities of other rare earths. In any event, the exact composition of the mischmetal is not important, since the above mentioned elements have similar chemical behavior, so that the chemical properties of the different types of mischmetals are essentially the same, as the content of the single element varies.

Other getter materials useful for the present invention are Y-V or Y-Al alloys containing at least 70% by weight of yttrium, that are particularly efficient for decreasing the hydrogen partial pressure in the final lamps.

The layer of getter material may have a thickness between a few microns (μm) and a few hundreds of microns, depending on the technique used to produce it (as specified in the following). In the case of hollow cathodes, this thickness is also a function of the diameter of the cavity. In the case of cathodes with a cavity diameter of about one millimeter, it is preferable that the thickness of the getter layer be as low as possible, provided that there is enough getter material to perform the impurities sorption function efficiently.

The layer of getter material (26; 31) may be deposited on the metallic part of the cathode in different ways.

According to a first embodiment, the layer of getter material may be obtained by cathodic deposition, a technique better known in the art of thin film manufacturing as “sputtering”. As known in this technique, the support to be coated (in this case the hollow cathode) and a generally cylindrical body, called the “target”, of a material of which the layer is to be obtained are arranged in a suitable chamber. A vacuum is produced in the chamber, and then a rare gas, usually argon, is introduced at pressures of about 10⁻²-10⁻³ mbar. Applying a potential difference between the support and the target (the latter kept at cathodic potential), a plasma is created in the argon, with formation of Ar⁺ ions, which are accelerated by the electric arc toward the target, thus eroding it by impact. The particles removed from the target (atoms or “bunches” of atoms) deposit on the available surfaces, including those of the support, thus forming a thin layer. For further details about principles and instructions for use of the technique, reference is made to the wide literature of the art. The productivity of the sputtering technique, as thickness of the layer deposited in a unit of time, is not very high. Therefore, this technique may be preferred when getter layers of thickness not greater than 20 μm must be produced, for example in the case of hollow cathodes of small diameter. Partial coating of the surfaces of the metallic part of the cathode may be obtained in this case using suitable supports of the parts which, during the sputtering process, also carry out the masking thereof. For example, the cathode of FIG. 2 may be manufactured using, during the sputtering, a cylindrical support, inside which is arranged the hollow cathode to be coated. Consequently, the support is in contact with the external surface of the cylindrical part 21, thus leaving only surface 24 exposed.

Another method for manufacturing a cathode with a coating of getter layer according to the invention is by an electrophoretic technique. The principles of manufacturing getter material layers in this manner are disclosed in U.S. Pat. No. 5,242,559 of SAES Getters S.p.A., to which reference is made for further details about the technique. In this case, the partial or total coating of the metallic part of the cathode may be simply obtained by partially or totally immersing the part in the coating bath. In this case, it is possible to selectively coat one of the two surfaces, internal or external, by using a suitable support of the metallic part. This technique is suitable for manufacturing getter layers thicker than those obtained by sputtering, with the opportunity to form layers of thickness up to a few hundred of microns easily and rapidly.

Finally, another available technique is spraying, wherein a suspension of getter particles in a suitable liquid means is used. The suspension is sprayed by a compressed gas (generally air) on the part to be coated, and the so obtained deposit is dried and solidified by thermal treatments. The use of the technique to obtain getter deposits is disclosed, for example, in U.S. Pat. No. 5,934,964 of SAES Getters S.p.A.

The invention will be further illustrated by the following examples.

### EXAMPLE 1

A layer about 1 μm thick of an alloy containing zirconium, cobalt and mischmetal is produced on a tungsten wire. The layer is obtained by sputtering starting from a target of St 787 alloy. As known in the art, different elements have different sputtering yields, so that starting from a multicomponent target, the final composition of the obtained layer is generally different from the target. In this case, the layer obtained on tungsten wire has a composition which, compared to that of the St 787 alloy, is enriched in zirconium and poorer in cobalt. On the so obtained wire a measurement of the work function is effected, according to ASTM F 83-71 standard procedure. In particular, the second available method according to this procedure, known as the “Schottky method” is followed. Also, the work function of a fragment of the same tungsten wire is measured, in this case however without the coating according to the invention.

The two tests produce, as a result, work function values Φ of about 4.5 eV for the uncoated tungsten and about 3 eV for the coated wire according to the invention, with a decrease of the Φ value of about 33%. The value of about 4.5 eV measured for the uncoated wire agrees with the values in the range 4.2-4.6 eV given in literature, confirming that the measurements have been carried out accurately.

### EXAMPLE 2

The test of Example 1 is repeated, in this case with the difference that the tungsten filament is covered with an yttrium-vanadium alloy film, produced by sputtering, starting with a target of weight percent composition Y 96%-V 4%. The work function value measured is about 3.1 eV, with a reduction of about 30% compared to pure tungsten.

### EXAMPLE 3

The test of Example 1 is repeated, this time using a nickel filament, measuring the Φ value on a fragment of the pure metallic wire and on a fragment of the same wire coated by sputtering, starting from a target of St 787 alloy. In this case, the values obtained are about 4.9 eV for the uncoated nickel and about 3.1 for the coated wire according to the invention, with a reduction of the Φ value of about 37%. In this case also, the Φ value measured on nickel agrees with the values given in literature, which are in the range 4.7-5.3 eV.

### EXAMPLE 4

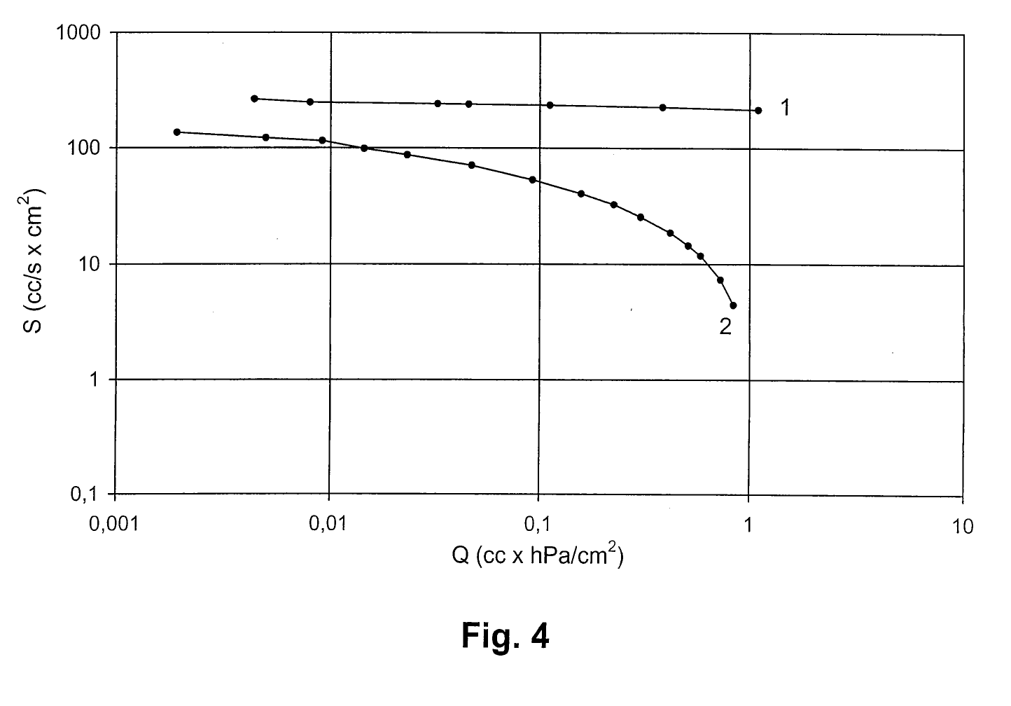

A specimen comprising a tungsten wire coated with a film of St 787 alloy, produced as described in Example 1, is subjected to a hydrogen sorption test. The specimen is introduced into a glass bulb, the bulb is evacuated, and the specimen is activated by heating at 400° C. during 30 minutes (by induction by a coil placed outside the glass bulb). The specimen is then allowed to cool down to 25° C., and the test is carried out by following the procedure described in standard ASTM F 798-82, with a hydrogen pressure of 4×10⁻⁶ mbar. The test results are reported in a graph as curve 1 in FIG. 4, with sorption velocity (indicated by S and measured in cubic centimeter (cc) of gas sorbed per second, normalized per square centimeter of alloy) plotted as a function of the quantity of sorbed gas (indicated by Q and measured in cubic centimeters of gas multiplied by the pressure of measurement in hectoPascal (hPa) and normalized per square centimeter of alloy).

### EXAMPLE 5

The test of Example 4 is repeated, this time using carbon monoxide as the test gas. The test results are reported in a graph as curve 2 in FIG. 4.

### EXAMPLE 6

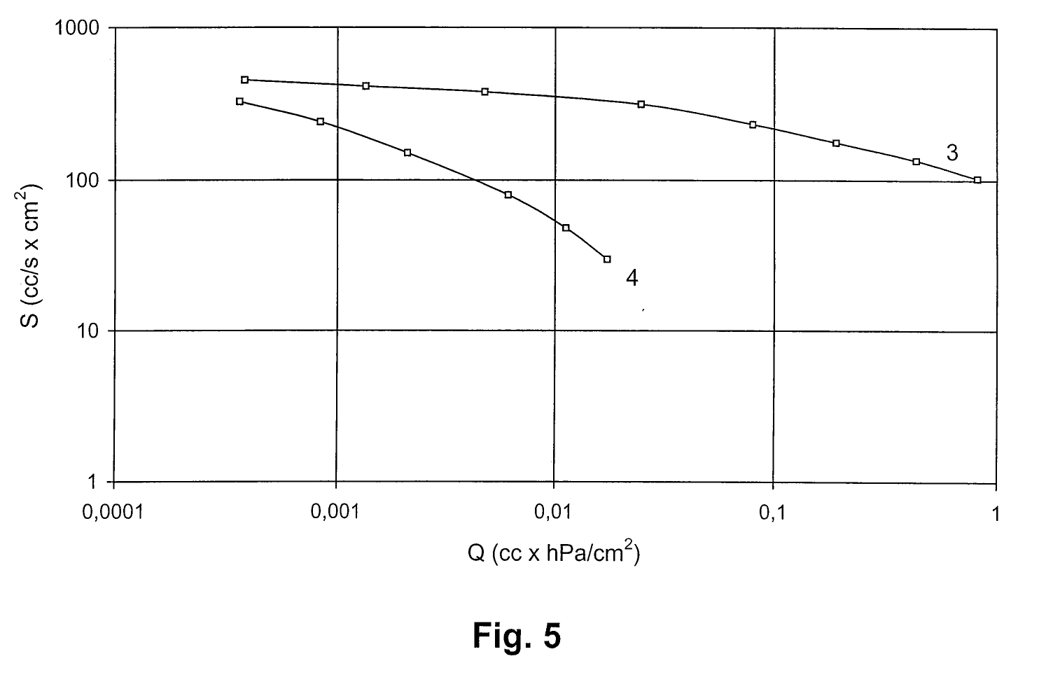

A specimen comprising a tungsten wire coated with a film of an Y-V alloy, produced as described in Example 2, is subjected to a hydrogen sorption test. The specimen is introduced into a glass bulb, the bulb is evacuated, the specimen is activated by induction heating at 500° C. for 10 minutes, and is then allowed to cool down to 25° C. The hydrogen sorption test is carried out as in Example 4. The test results are reported in a graph as curve 3 in FIG. 5.

### EXAMPLE 7

The test of Example 6 is repeated, this time using carbon monoxide as the test gas. The test results are reported in a graph as curve 4 in FIG. 5.

The tests confirm that the coating of a metallic cathode with a getter, according to the invention, allows a notable decrease of the work function value of the cathode. The cathodes of the invention also show good gas sorption properties, as evidenced by the test results of Examples 4 to 7.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A cathode (11; 20; 30) for cold cathode lamps with integrated getter and with a reduced work function value, the cathode comprising a metallic bearing part (12; 21, 22; 32) at least partially coated with a layer of getter material (15; 26; 31), wherein the getter material is selected from:
alloys comprising zirconium, cobalt and at least one component selected from yttrium, lanthanum and rare earths such that, in a ternary diagram of weight % compositions, the alloys are enclosed in a polygon defined by the following points:
a) Zr 81%-Co 9%-A 10%
b) Zr 68%-Co 22%-A 10%
c) Zr 74%-Co 24%-A 2%
d) Zr 88%-Co 10%-A 2%
wherein A is an element selected from yttrium, lanthanum, rare earths, and mixtures thereof;
alloys consisting of yttrium and aluminum containing at least 70% by weight yttrium; and
alloys consisting of yttrium and vanadium containing at least 70% by weight yttrium.

2. The cathode according to claim 1, wherein the metallic bearing part comprises a metal selected from nickel, molybdenum, tungsten, niobium and tantalum.

3. The cathode according to claim 2, wherein the metallic bearing part has a shape selected from a strip, a full cylinder and a hollow cylinder.

4. A method for manufacturing a cathode according to claim 1, wherein the getter material layer is formed by cathodic deposition.

5. The method according to claim 4, wherein the getter material layer has a thickness of less than 20 μm.

6. The method according to claim 4, wherein the metallic bearing part (21, 22; 32) has a shape of a hollow cylinder, and wherein during the cathodic deposition the part is at least partially coated on one or both internal and external surfaces of the cylinder by masking with a suitably shaped support element.

7. The method for manufacturing a cathode according to claim 1, wherein the getter material layer is formed by electrophoretic deposition.

8. The method according to claim 7, wherein the metallic bearing part (21, 22; 32) has a shape of a hollow cylinder, and wherein during the electrophoretic deposition the part is at least the partially coated on one or both internal and external surfaces of the cylinder by partial immersion in a liquid suspension containing getter particles used for the deposition.

9. The method according to claim 8, further including the step of masking one of the surfaces to achieve the partial coating.
